(19) United States
(12) Patent Application Publication
(10) Pub. No.: US 2008/0073485 A1
(43) Pub. Date: Mar. 27, 2008

(54) Visual inspection of optical elements

(76) Inventors: Robert Jahn, Jettingen (DE); Josef Beller, Tuebingen (DE); Peter Hoffmann, Klagenfurt (AT)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/526,440

(22) Filed: Sep. 25, 2006

(51) Int. Cl. G01N 21/00; G02B 27/40

(52) U.S. Cl. 250/201.2; 356/73.1

(57) ABSTRACT

An optical imaging device for visually inspecting an optical element is described. The optical imaging device comprises an optical connector interface adapted for connecting the optical imaging device to the optical element, an imaging unit adapted for acquiring image data of the optical element's surface, and a display for visualizing the image data. The optical imaging device further comprises a focus evaluation facility adapted for deriving a focus evaluation value indicating the instantaneous image definition of the acquired image, said focus evaluation value being derived from at least one of: the acquired image data itself and additional signals related to the position of the imaging unit relative to the surface of the optical element. The focus evaluation value is usable as a focussing aid for either automatically or manually adjusting the focus.

### BACKGROUND OF THE INVENTION

The present invention relates to an optical imaging device for visually inspecting an optical element, and to a method for visually inspecting an optical element. Furthermore, the present invention relates to a software program or product adapted for being executed on a processing unit of an optical imaging device.

Optical elements are generally very susceptible for contamination, dirt, scratches, and so on, which can cause faults such a increased bit error rate, signal degradation, or increased insertion loss. A visual inspection of optical elements might therefore be applied. Typically, such visual inspection is carried out using an optical imaging device adapted for field applications.

### SUMMARY OF THE INVENTION

It is an object of the invention to improve the visual inspection of optical elements. The object is solved by the independent claims. Preferred embodiments are shown by the dependent claims.

An optical imaging device according to embodiments of the present invention is adapted for visually inspecting an optical element and comprises an optical connector interface that is adapted for connecting the optical imaging device to the optical element. The optical imaging device further comprises an imaging unit adapted for acquiring image data of the optical element's surface, and a display for visualizing the image data. The optical imaging device further comprises a focus evaluation mechanism that is adapted for deriving a focus evaluation value indicating the instantaneous image definition of the acquired image. The focus evaluation value is derived from at least one of: the acquired image data itself and additional signals related to the position of the imaging unit relative to the surface of the optical element. The focus evaluation value is usable as a focussing aid for either automatically or manually adjusting the focus.

Typically, optical elements like e.g. fibers, fiber connections, optical components in a fiber network, etc. have to be inspected at places where only a small amount of space is available, such as e.g. in a man hole. For inspecting the optical elements, the technical staff is usually equipped with optical imaging devices that can be connected, via an optical connector interface, with the respective optical element. The optical imaging device comprises an imaging unit for acquiring an image of the optical element's surface. The acquired images are displayed to a technical staff member who has to check the status and the functionality of the optical element.

The focus evaluation mechanism according to embodiments of the present invention allows to adjust the focus of the acquired image more quickly. An image of good definition is obtained more quickly. An increased number of optical elements can be checked per unit time, and the throughput is increased. Besides that, it is rather annoying for a technical staff member to refocus many times before a respective fault is found. In this respect, the focussing aid provided by embodiments of the present invention is capable of improving the conditions of work.

The optical imaging device according to embodiments of the present invention can be used for inspecting all kinds of optical elements like e.g. fibers, fiber connections, and other optical components of a fiber optic network.

In a preferred embodiment, the optical imaging device comprises a processing unit. For example, image data acquired by the imaging unit might be subjected to image processing before it is displayed. Image processing permits to vary image parameters such as contrast, brightness, sharpness, etc. Furthermore, image processing might as well be used for detecting faults such as e.g. scratches, particles such as dirt, fluid films, etc. on the optical element's surface. Faults or contamination of this kind can e.g. be identified using pattern recognition based on two-dimensional correlation procedures. The faults that have been identified can be indicated using different coloring schemes.

According to another preferred embodiment, the optical imaging device is combined with a measuring unit. The measuring unit allows determining an optical property of the optical element or the fiber optic network, whereas the optical imaging device acquires the imaging data for visualizing the surface of the optical element. By combining the two approaches, a quick and accurate examination of the optical elements is possible. A device that combines the imaging functionality with a measuring capability permits to reduce the space required for the measurement set-up. One screen is used for displaying both images and measurement results.

According to the preferred embodiments, the measuring unit might e.g. comprise an optical time domain reflectometer (OTDR) adapted for analyzing light that has been backscattered by the optical element. Additionally or alternatively, the measuring unit might e.g. comprise at least one of a WDM (Wavelength Division Multiplexing) measuring unit, and a dispersion measuring unit.

In a preferred embodiment, the image data acquired by the imaging unit and the measurement data provided by the measuring unit are both processed by one common processing unit. Alternatively, the optical imaging device can be provided with a separate processing unit.

A first possibility for deriving the focus evaluation quantity is to perform image processing of the acquired image data. Image processing techniques allow to derive a measure of the image definition.

In a preferred embodiment, instead of utilizing the entire image data for deriving the focus evaluation value, only a small part of the image data in a predefined region of interest (ROI) is used for evaluating the image definition. As a consequence, the computational burden is reduced.

According to a preferred embodiment of the invention, the focus evaluation value can be obtained by applying a gradient operator to the acquired image, and by accumulating the absolute values of the image's gradient. An image of good definition is characterized by steep transitions of the image's brightness. In contrast, in a blurred image, there only exist slowly varying transitions of the image's brightness. For this reason, the summed-up absolute values of the derivatives of the image's brightness can be used as a measure of the image's definition. In this respect, a small value of the summed-up gradient corresponds to an image that is out of focus, whereas a large value of the summed-up gradient corresponds to a good image definition. Similarly, the Sum Modulus Difference (SMD) of the acquired image data can be used as a focus evaluation value.

According to an alternative embodiment of the invention, the determination of the focus evaluation value is based on a one- or two-dimensional discrete Fourier transform of the acquired image data. In particular, the original image data can be subjected to a fast Fourier transform (FFT), which allows to determine the spatial frequency components with low computational expense. As a result of the Fourier transform, one- or two-dimensional spectra of the image's spatial frequency components are obtained. Based on these spectra, a measure of the image definition can be derived.

According to another preferred embodiment, once the spectrum of spatial frequency components is available, the image definition can be obtained by evaluating the upper frequency range of the spectrum. An image of good definition contains the whole range of spatial frequency components, whereas in an image that is out of focus, the high-frequency part of the spatial frequency spectrum has been attenuated. The image definition can be determined by evaluating the amount of high-frequency components of the spatial frequency spectrum. The amount of high-frequency components can be used as a measure of the image definition.

In a preferred embodiment, the focus evaluation value is obtained by integrating the high-frequency part of the spatial frequency spectrum. Starting at a predefined threshold, the discrete values of the spectrum that has been obtained by performing a Fourier transform are summed up. The summed-up value gives an indication about the image sharpness. A maximum search yields the optimum focus adjustment. In case the obtained value is rather small, the image is out of focus.

In the embodiments that have been discussed so far, the focus evaluation value is determined by means of image processing. Alternatively, the focus evaluation value can be derived from additional signals related to the position of the imaging unit relative to the surface of the respective optical element.

According to a preferred embodiment, the optical imaging device comprises a light source, preferably a LED or laser source, adapted for directing a beam of light onto the optical element's surface. The beam of light is directed towards the surface at a predefined angle. The surface is imaged, and the position of the light spot that corresponds to the light beam is determined. The position of the light spot depends on the distance between the imaging unit and the surface. From the position of the light spot, the focus evaluation value can be derived.

In another preferred embodiment, the optical imaging device comprises a light source, preferably a LED or laser source. The light beam emitted by the light source is directed to and reflected by the surface of the optical element. The position of the reflected light beam is detected, e.g. by means of multi-segment diode, and the focus evaluation value is derived there from. In this embodiment, the focus evaluation value is determined using a triangulation method. Both the light source and the detection unit, e.g. the multi-segment diode, are placed at predetermined angles relative to the optical element's surface. Therefore, they do not obstruct the light path of the imaging unit.

The focus evaluation value that has been determined in accordance with one of the possibilities that have been described above can be used as a focussing aid for either automatically or manually adjusting the focus. Preferably, in case the focus is adjusted manually, a feedback signal indicating the instantaneous image definition is communicated to the user. For this purpose, the optical imaging device might comprise a feedback unit adapted for generating a feedback signal that corresponds to the focus evaluation value. In accordance with the feedback signal, the user can adjust the focus until an optimum image definition is reached. Hence, the adjustment of the focus is simplified and can be performed more quickly.

According to a preferred embodiment, the optical imaging device comprises an acoustic or tactile feedback unit that provides an acoustic or tactile feedback signal to the user. In order to find the optimum image definition, the user can vary the focus while listening to the acoustic or sensing the tactile feedback signal. In this embodiment, the user does not have to watch a display while manually adjusting the focus.

According to alternative embodiments, digits or symbols indicating the focus evaluation value are displayed to the user. Thus, the user is provided with precise information about the instantaneous image definition.

Alternatively, the focus of the imaging unit can be adjusted automatically. In a preferred embodiment, the optical imaging device comprises an autofocus control module that is adapted for varying the focus until an optimum image definition is accomplished. Focussing is carried out automatically, and the user does not have to care about adjusting the focus.

In yet another preferred embodiment, the optical imaging device comprises a controlled actuator adapted for adjusting the focus. For example, the controlled actuator might vary the focus of the imaging unit's objective. Alternatively or additionally, the controlled actuator might e.g. reposition the imaging unit relative to the imaged surface.

According to another aspect, an optical imaging device for visually inspecting an optical element comprises an optical connector interface adapted for connecting the optical imaging device to the optical element, an imaging unit adapted for acquiring image data of the optical element's surface, and a display for visualizing the image data. The optical imaging device further comprises a signal light detection unit adapted for detecting the presence of a signal light component received via the optical element. Thus, the user can be informed about the presence of signal light components when inspecting the optical element. For example, the user might be informed about the presence of visible or non-visible light components such as IR light components.

According to yet another aspect, an optical imaging device for visually inspecting an optical element comprises an optical connector interface adapted for connecting the optical imaging device to the optical element, an imaging unit adapted for acquiring image data of the optical element's surface, and a display for visualizing the image data. Furthermore, the optical imaging device is equipped with a visual inspection tool comprising a light source, preferably a laser source, with the visual inspection tool being adapted for coupling visible light into the optical element. Any kind of unintentional light emission in a fiber under test might be considered as an indication of an optical fault. By coupling visible light into the optical element, faults of this kind can be identified.

According to yet another aspect, an optical imaging device for visually inspecting an optical element comprises an optical connector interface adapted for connecting the optical imaging device to the optical element, an imaging unit adapted for acquiring image data of the optical element's surface, and a display for visualizing the image data. The optical imaging device further comprises a cleaning facility adapted for cleaning the surface of the optical element.

Embodiments of the invention can be partly or entirely embodied by a software program or product that is adapted for being executed on a processing unit of an optical imaging device. The software program or product comprises an image display module adapted for receiving image data acquired by an imaging unit, and for processing the image data to be displayed by a display. The software program or product further comprises an image definition evaluation module adapted for performing image processing of the acquired image data, in order to derive a focus evaluation value indicating the instantaneous image definition, whereby the focus evaluation value is used as a focussing aid for either automatically or manually adjusting the focus. A focussing aid that is based on image processing can thus be implemented as a software program or product. Optical imaging devices that do not comprise a focus evaluation facility yet can later on be equipped with a focussing aid. Thus, an existing imaging device can be upgraded by installing a suitable software module.

### BRIEF DESCRIPTION OF THE DRAWINGS

Other objects and many of the attendant advantages of the present invention will be readily appreciated and become better understood by reference to the following detailed description when considering in connection with the accompanied drawings. Features that are substantially or functionally equal or similar will be referred to with the same reference sign(s).

FIG. 1 shows an optical imaging unit for inspecting the optical element's surface;

FIG. 2 depicts an image of an optical element's surface;

FIG. 3 shows how a measuring unit and an imaging unit can be combined in order to form one integrated device;

FIG. 4 shows a multitude of frequency response curves that correspond to different values of σ;

FIG. 5A gives a spatial frequency spectrum of an image that is out of focus;

FIG. 5B shows a spatial frequency spectrum of a focussed image;

FIG. 6 shows an optical imaging unit comprising a triangulation facility;

FIG. 7 depicts a visual inspection tool according to the prior art; and

FIG. 8 shows a multipurpose optical imaging unit comprising a variety of different features.

### DETAILED DESCRIPTION OF EMBODIMENTS OF THE INVENTION

FIG. 1 shows an optical imaging unit 1 that allows to visually inspect an optical element 2. The optical imaging unit 1 is employed for visually inspecting the surface of an optical fiber 3 that is surrounded by a metal or ceramic ferule 4. For this purpose, the optical imaging device 1 comprises a connector interface 5. The optical imaging unit 1 might e.g. be implemented as an electronic video microscope comprising an objective lens system 6 and an imaging unit 7, which might e.g. comprise a light sensitive chip that converts an optical image into corresponding imaging signals. Optionally, the imaging signals can be subjected to some kind of image processing. Then, the acquired image is displayed on a monitor. Typically, in field applications, an electronic video microscope consisting of camera unit, monitor, and battery pack is utilized for checking optical fiber connections.

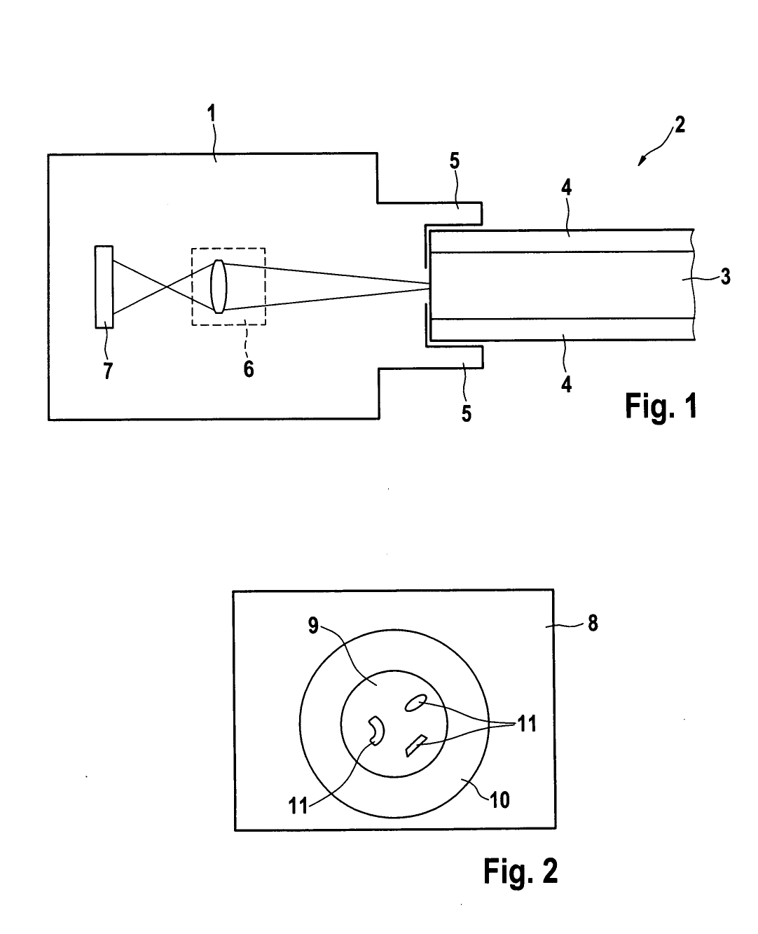

FIG. 2 shows an image 8 of an optical element that has been acquired by the optical imaging unit shown in FIG. 1. The image 8 shows the optical element's surface with a fiber 9 in the center, and with a metal or ceramic connector ferule 10 surrounding the fiber 9. Optical fiber connections are generally very susceptible to contamination with dirt and fluids, scratches, dust and so on, which can cause faults, such as increased insertion loss, higher bit error rate, or signal degradation to the fiber connection and the traffic signal on the fiber. Faults 11 can be detected by visually inspecting the image provided by the camera unit. Alternatively or additionally, the acquired image can be subjected to image processing, e.g. by using pattern recognition. In any case, before any further analysis can be performed, it has to be made sure that a high quality image of the optical fiber connection is acquired. In particular, for obtaining images of satisfactory definition, it should be made sure that the optical lens system is precisely focussed onto the optical element's surface.

According to a first possibility, the focus of the image 8 can be evaluated by means of image processing. The imaging signals provided by the camera unit are supplied to a processing unit, and a focus evaluation value is derived there from.

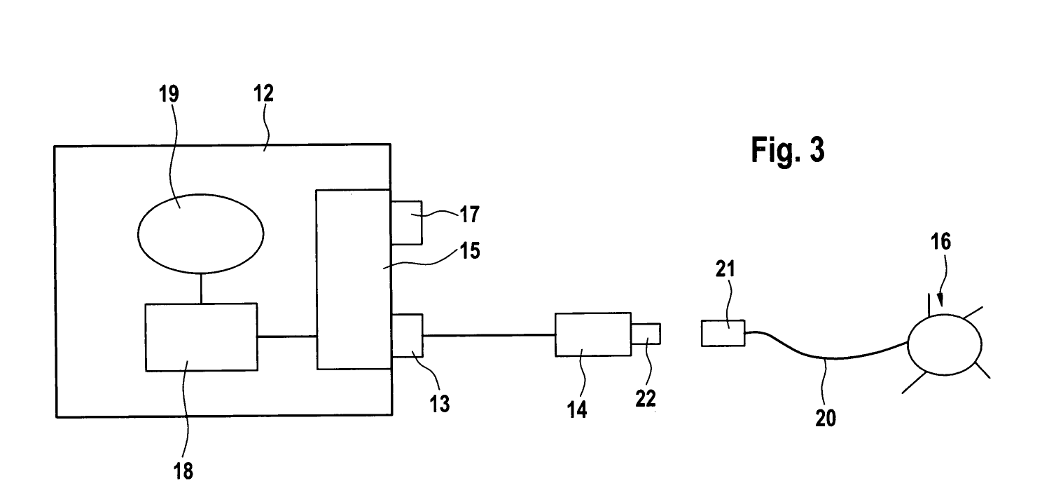

In FIG. 3, another set-up for visually inspecting optical fiber connections is shown. An optical measuring device 12 comprises an interface 13, such as a standard USB interface, for coupling an optical imaging unit 14 to the optical measuring device 12. The optical measuring device 12 comprises a measuring unit 15 that is adapted to provide measurements in a fiber optic network 16, which consists of one or more fibers and which might comprise further optical components. For performing the measurement, the measuring unit 15 can be coupled, via a connection 17, to the fiber optic network 16. A processing unit 18 is coupled to the measuring unit 15 in order to process measuring signals received from the measuring unit 15. Imaging signals from the optical imaging unit 14 are either routed to the processing unit 18 via the measuring unit 15, or are directly forwarded to the processing unit 18. The processing unit 18 receives the measuring signals acquired by the measuring unit 15 through the connection 17 and/or the imaging signals as provided by the optical imaging unit 14, and processes the received signals. Then, the processed signals are displayed on a display 19. The measuring unit 15 might e.g. be adapted for performing at least one of: an OTDR (Optical Time Domain Reflectometer) measurement, a WDM (Wavelength Division Multiplexing) test, a dispersion test, etc.

In a first operation mode, the optical measuring device 12 is used for providing measurements of the fiber optic network 16. For this purpose, a fiber 20 of the fiber optic network 16 is coupled to the connection 17, e.g. by means of a fiber connector 21. In a second operation mode, the optical measuring device 12 is used for providing a visual inspection of fibers or components of the fiber optic network 16. In this second operation mode, the imaging unit 14 provides imaging signals from the optical devices to be inspected. For this purpose, the objective 22 of the imaging unit 14 is connected to the fiber connector 21. The optical measuring device 12 can be operated in either one of the two operation modes as well as in a combined first and second operation mode that allows to concurrently perform optical measurements and visual inspection.

The processing unit 18 comprises suitable software modules for processing measurement signals provided by the measurement unit 15 as well as for processing imaging signals provided by the imaging unit 14.

In order to evaluate the image definition of the acquired image, the processing unit 18 might derive a focus evaluation value from the acquired imaging signals, e.g. by means of image processing. Preferably, only image data within a predefined region of interest (ROI) is used for determining the focus evaluation value.

If an image is well-focussed, each point of an object will correspond to a small image point in the image plane. However, if the image is out of focus, each point of the object will be transformed into a corresponding brightness distribution. With x, y denoting the coordinate values in the image plane, the brightness distribution of a point source's image can be written as:

$$h ( x , y ) = \frac{1}{2 π {σ}^{2}} {e}^{- \frac{1}{2} \frac{{x}^{2} + {y}^{2}}{{σ}^{2}}}$$

The term x²+y² can be replaced by r²=x²+y². Hence, the brightness distribution can be written as

$$h ( r ) = \frac{1}{2 π {σ}^{2}} {e}^{- \frac{1}{2} \frac{{r}^{2}}{{σ}^{2}}}$$

In this Gaussian distribution, the optical properties of the objective lens system are described by the parameter σ. For σ=0, the image is in focus. For large values of σ, the image will appear blurred. A large value of σ corresponds to a spread-out spatial distribution of the brightness in the image plane. The function h(r) is generally referred to as the point response of the objective lens system. As soon as the point response h(r) is known, an image can be calculated by convoluting an input signal with the point response.

According to the convolution theorem, the spatial frequency spectrum of the image can be represented as the product of the input signal's Fourier transform with a transfer function H(ρ), which is obtained as the Fourier transform of h(r)

$$H ( ρ ) = \frac{1}{\sqrt{2 π {σ}^{2}}} {e}^{- \begin{matrix}1 \\ 2\end{matrix} {σ}^{2} {ρ}^{2}} , \qquad$$

whereby ρ denotes a spatial frequency. Multiplying the input signal's spatial frequency spectrum with the Gaussian distribution H(ρ) induces a suppression of the spatial frequency spectrum's high-frequency components. The degree of suppression of high frequency components is determined by the parameter σ. If the image is out of focus, the value of σ will be large, and the objective lens system will act as a low pass filter.

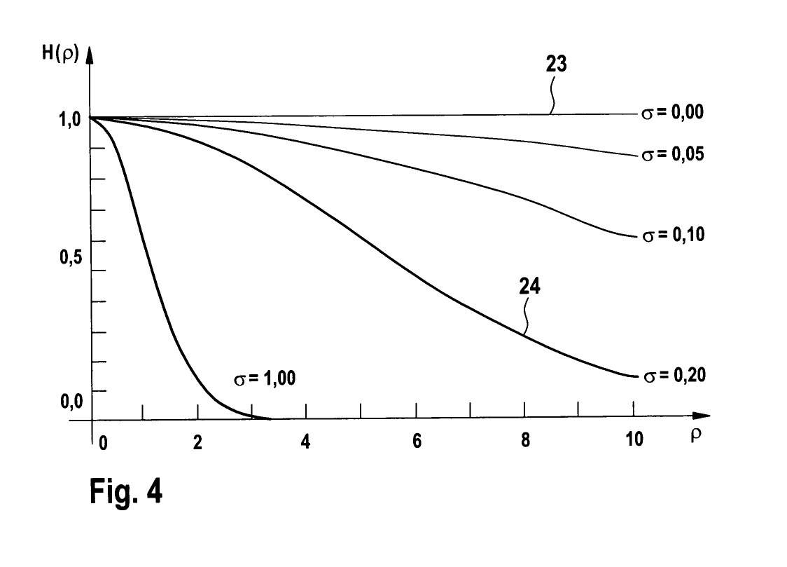

In FIG. 4, the transfer function H(ρ), which is also referred to as the system's frequency response curve, is depicted for different values of the parameter σ. The frequency response curve 23 corresponds to σ=0. In this case, the high-frequency part of the spatial frequency spectrum is not suppressed at all. This case corresponds to a perfectly focussed image. In contrast, a large value of σ corresponds to an image that is out of focus. From the frequency response curve 24, which corresponds to σ=0.20, it can be seen that H(ρ) is small for large spatial frequencies. Therefore, the high-frequency part of the spectrum is attenuated.

The spatial frequency spectrum of an image can be used for evaluating the image definition. An image that is in focus will possess a maximum amount of high-frequency components, whereas in an image that is out of focus, the high frequency components will be missing.

In the literature, a number of different functions for evaluating image definition have been described. For example, in the dissertation “Ein Beitrag zur Kamerafokussierung bei verschiedenen Anwendungen der Bildverarbeitung” bei Bingzi Liao, Universität der Bundeswehr Hamburg, July 1993, eight different functions for evaluating the definition of an image are described. This dissertation, and in particular the description of the eight different focus evaluation functions, is herewith incorporated by reference into the description of the present application.

In general, when devising a focus evaluation function, the strategy is to determine a measure of the spatial frequency spectrum's high-frequency part.

A first strategy is to determine a two-dimensional discrete Fourier transform G(u, v) of the image g(x, y) and to sum up or integrate the high-frequency part of the corresponding power spectrum |G(u, v)|².

The two-dimensional discrete Fourier transform of g(x, y) can be determined as

$$G ( u , v ) = \frac{1}{NM} {\sum }_{x = 0}^{N - 1} {\sum }_{y = 0}^{M - 1} g ( x , y ) \cdot exp ( - 2 π j ( \frac{x \cdot u}{N} + \frac{y \cdot v}{M} ) ) .$$

However, the calculation of a two-dimensional Fourier transform is computationally expensive. Therefore, it is advantageous to determine G(u, v) according to a sequence of a first and a second one-dimensional Fourier transforms. For an N×N image, a one-dimensional discrete Fourier transform of the N columns is determined as:

$$G ( x , v ) = \frac{1}{N} {\sum }_{y = 0}^{N - 1} g ( x , y ) \cdot exp ( - 2 π j \frac{y \cdot v}{N} )$$

Next, a one-dimensional discrete Fourier transform of the N rows is performed in accordance with:

$$G ( u , v ) = \frac{1}{N} {\sum }_{x = 0}^{N - 1} G ( x , v ) \cdot exp ( - 2 π j \frac{x \cdot u}{N} )$$

Preferably, a one-dimensional FFT (Fast Fourier Transform) algorithm is employed for each of the one-dimensional Fourier transforms. It goes without saying that the order of performing the two one-dimensional Fourier transforms related to the image's rows and columns can be interchanged.

Once G(u, v) has been determined, a focus evaluation function LS can be obtained as

$$LS = {\sum }_{u ∈ ψ} {\sum }_{v ∈ ψ} {\vert G ( u , v ) \vert}^{2} ,$$

whereby ψ denotes the high-frequency region of the two-dimensional spatial frequency plane.

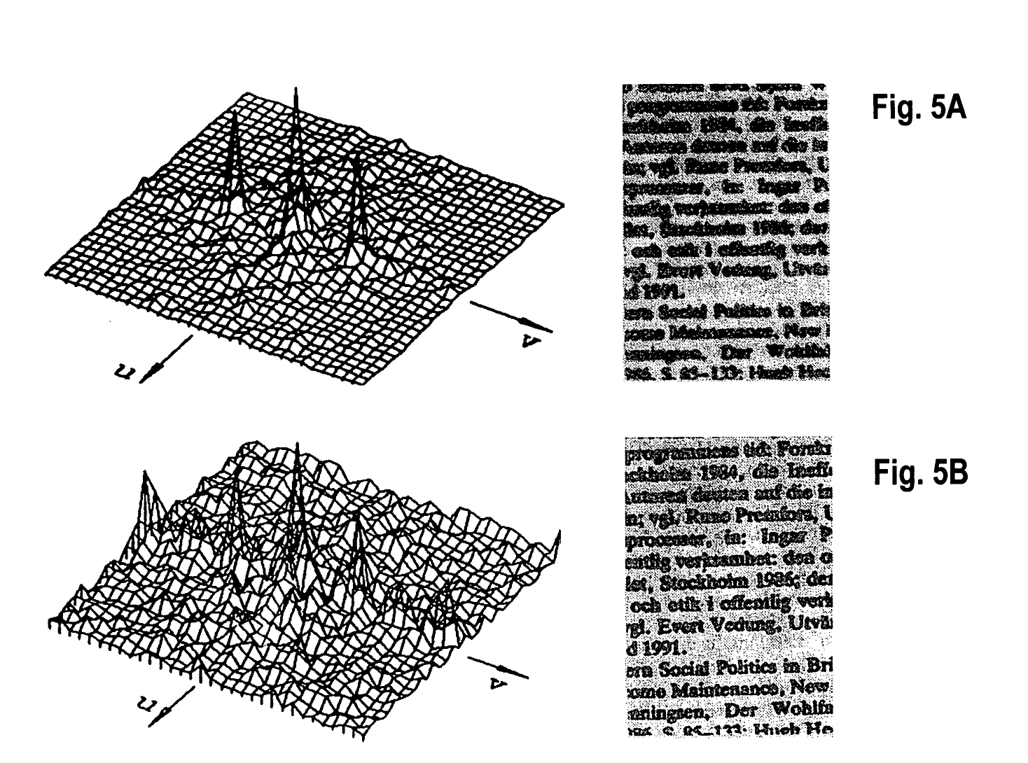

The right hand side of FIG. 5A depicts an image that is out of focus. On the left hand side of FIG. 5A, the corresponding spectrum of two-dimensional spatial frequencies (u, v) is shown. It can be seen that the high-frequency part of the spectrum is suppressed.

In contrast, on the right hand side of FIG. 5B, an image of good image definition is shown. The corresponding spectrum of spatial frequencies is depicted on the left hand side of FIG. 5B. It can be seen that the spectrum of a well-focussed image is characterized by a large amount of high-frequency spectral components.

Another possibility is to use the gradient of the image g(x, y) as a starting point for deriving a focus evaluation function. The Fourier transform of a gradient operator can be written as:

$$\frac{\partial }{\partial x} g ( x , y ) ⇔ j u \cdot G ( u , v )$$

$$\frac{\partial }{\partial y} g ( x , y ) ⇔ j v \cdot G ( u , v )$$

Applying a gradient operator to g(x, y) is equivalent to multiplying the spatial frequency spectrum with the respective spatial frequency u or v. Accordingly, applying a gradient operator to g(x, y) lifts the high-frequency part of the spatial frequency spectrum. The summed-up absolute values of the image's gradient can therefore be taken as a measure of the image's high frequency components. For example, in a blurred image, there do not exist any sharp transitions, and for this reason, the absolute value of the gradient remains relatively small.

For discrete values g(x, y), the gradient can be approximated by the corresponding difference quotients:

$$\begin{matrix}\frac{\partial g ( x , y )}{\partial x} \approx \frac{g ( x , y ) - g ( x - 1 , y )}{x - ( x - 1 )} \\ = g ( x , y ) - g ( x - 1 , y )\end{matrix}$$

$$\begin{matrix}\frac{\partial g ( x , y )}{\partial y} \approx \frac{g ( x , y ) - g ( x , y - 1 )}{y - ( y - 1 )} \\ = g ( x , y ) - g ( x , y - 1 )\end{matrix}$$

For evaluating the focus of the image, the absolute values of the difference quotients are summed up. Thus, the so-called “Sum Modulus Difference” (SMD) is obtained, which is a measure for the image's absolute gradient. The Sum Modulus Difference (SMD) can be determined in three different ways. For example, for an N×M image, the Sum Modulus Difference SMD1, which is determined as

$$\begin{matrix}SMD 1 = {\sum }_{y = 0}^{M - 1} {\sum }_{x = 0}^{N - 1} \vert \frac{\partial g ( x , y )}{\partial x} \vert \\ \approx {\sum }_{y = 0}^{M - 1} {\sum }_{x = 0}^{N - 1} \vert g ( x , y ) - g ( x - 1 , y ) \vert ,\end{matrix}$$

extracts the gradient along the x-axis. Correspondingly, the Sum Modulus Difference SMD2

$$\begin{matrix}SMD 2 = {\sum }_{x = 0}^{N - 1} {\sum }_{y = 0}^{M - 1} \vert \frac{\partial g ( x , y )}{\partial y} \vert \\ \approx {\sum }_{x = 0}^{N - 1} {\sum }_{y = 0}^{M - 1} \vert g ( x , y ) - g ( x , y - 1 ) \vert ,\end{matrix}$$

extracts the gradient along the y-axis. For considering both the contributions of gradients in the x- and y-direction, it is advantageous to determine a Sum Modulus Difference SMD3 that is based on the gradient's absolute values:

$$\begin{matrix}SMD 3 = {\sum }_{x = 0}^{N - 1} {\sum }_{y = 0}^{M - 1} \sqrt{{( \frac{\partial g ( x , y )}{\partial x} )}^{2} + {( \frac{\partial g ( x , y )}{\partial y} )}^{2}} \\ \approx {\sum }_{x = 0}^{N - 1} {\sum }_{y = 0}^{M - 1} \sqrt{{( g ( x , y ) - g ( x - 1 , y ) )}^{2} + {( g ( x , y ) - g ( x , y - 1 ) )}^{2}}\end{matrix}$$

In the solutions that have been described so far, the focus evaluation value has been derived by processing the acquired image data. Another possibility is to add additional hardware to the optical imaging unit, with said hardware being adapted for measuring a distance between the optical imaging unit and an optical element's surface, in order to generate a focus evaluation signal. Preferably, the optical imaging unit is equipped with a triangulation unit.

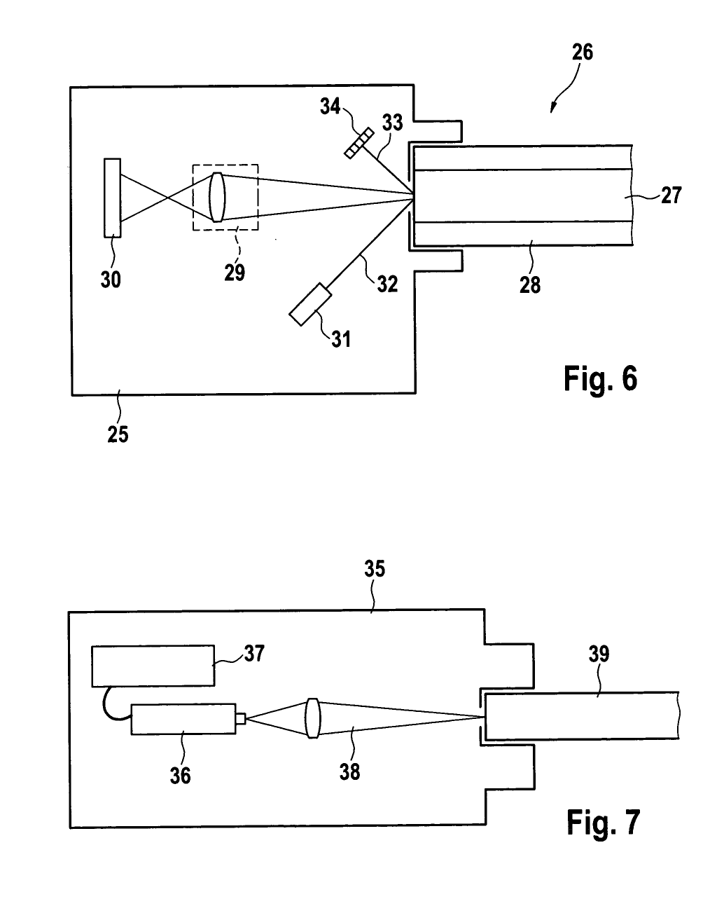

A solution of this kind is shown in FIG. 6. The optical imaging unit 25 is adapted for visually inspecting the surface of the optical element 26, which might e.g. comprise a fiber 27 and a metal or ceramic ferule 28. For inspecting the fibers surface, the optical imaging unit 25 comprises an objective 29 and a detection unit 30, which might e.g. be a CCD chip. The optical imaging unit 25 further comprises a LED or a laser 31, with a light beam 32 being directed to and reflected from the fiber's surface. The position of the reflected beam 33 is detected by means of a multisegment diode 34 with several light-sensitive segments, whereby the signals that correspond to the various segments are used for analyzing the reflected beam's position. The output signals of the multisegment diode 34 might e.g. be forwarded to a processing unit that determines the relative distance between the optical imaging unit and the inspected surface. The multisegment diode's output signals can be transformed into a corresponding focus evaluation signal.

Another alternative solution for determining the distance between the optical imaging unit 25 and the optical element 26 is to analyze, by means of image processing, the position of a light spot of the light beam 32 on the optical element's surface. The light beam 32 is directed towards the fiber's surface at a predefined angle of incidence. The position of the light spot on the fiber's surface can be used for deriving the relative distance between the optical imaging unit 28 and the fiber's surface.

The focus evaluation value that has been determined by one of the above described techniques can be indicated to the user as a focussing aid. In this semi-automatic approach, the user is responsible for manually adjusting the focus of the optical imaging unit. For example, the focus evaluation value can be converted into corresponding figures or symbols that are displayed to the user. Alternatively, the focus evaluation value can be converted into an acoustic signal, or into a tactile feedback signal. For example, the frequency of a focus evaluation tone can be varied in accordance with the instantaneous image definition. While listening to the tone, the user can adjust the focus until the highest possible (or lowest possible) frequency is reached.

Alternatively, the optical imaging unit can be provided with an autofocus unit adapted for automatically adjusting the focus. For this purpose, the optical imaging unit might be equipped with an actuator for electromechanically varying the distance between the optical imaging unit and the optical element, or for adjusting the focus of the objective lens system.

For detecting faults of an optical fiber connection, it is advantageous to use a visual inspection tool like the one shown in FIG. 7. The visual inspection tool 35 comprises a laser source 36 powered by a battery 37, which emits a beam of visible light 38. The beam of visible light 38 is focussed onto the surface of a fiber 39. Thus, visible light can be coupled into the fiber connection. Then, the fiber can be visually inspected. If visible light is emitted at any location of the optical light path, this will provide a strong indication that there is an optical fault. In particular, if visible light is emitted at a spliced connection between two optical fibers, the spliced connection is most probably faulty.

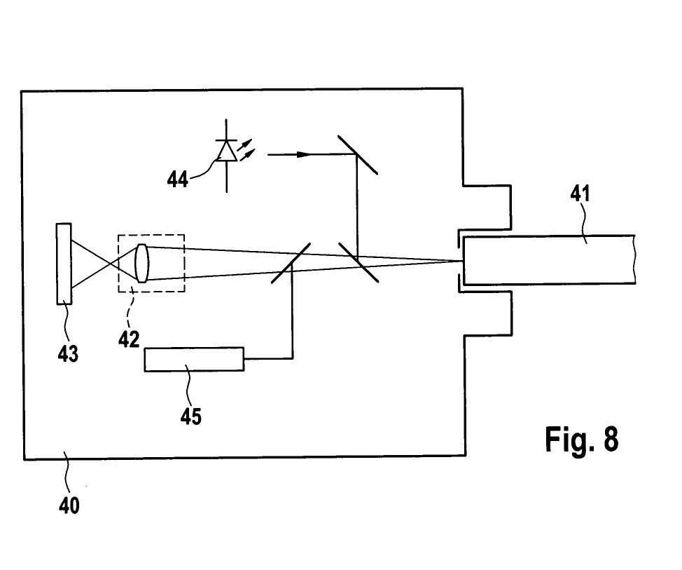

A visual inspection tool like the one shown in FIG. 7 can be integrated into an optical imaging unit. A multipurpose solution of this kind is depicted in FIG. 8. The optical imaging unit 40, which is adapted for imaging the surface of the fiber 41, comprises an objective lens system 42 and a detection unit 43. The optical imaging unit further comprises a light source 44 that is adapted for illuminating the surface of the fiber 41. The illumination light path might further comprise at least one of lenses, mirrors, partly reflecting mirrors, and other optical components. To allow for a visual inspection of the fiber 41, the optical imaging unit 40 comprises a laser source 45 that is adapted for coupling visible light into the fiber 41. The visual inspection light path might further comprise at least one of lenses, mirrors, partly reflecting mirrors, and other optical components.

Furthermore, the optical imaging unit 40 can be equipped with a signal light detection unit. In case a signal light component is received via the fiber 41, the presence of this signal light component can be detected and indicated to the user. In particular, the user can be informed about the presence of non-visible light components, e.g. of signal light components in the infrared.

Furthermore, the optical imaging device might comprise a cleaning facility that allows to remove dirt or fluid films (such as oil films) that contaminate the optical element's surface. For example, the fiber's surface can be cleaned by means of an air jet that is directed to the fiber's surface. In this embodiment, it has to be made sure that the air jet is oil-free. It might therefore be advantageous to utilize a compressor unit comprising an oil interceptor. Another possibility is to provide means for immersing the fiber's surface into an ultrasonic cleaning facility. Alternatively or additionally, the optical imaging unit might be equipped with one or more brushes adapted for mechanically cleaning the optical element's surface.

1. An optical imaging device for visually inspecting an optical element the optical imaging device comprising:
an optical connector interface adapted for connecting the optical imaging device to the optical element;
an imaging unit adapted for acquiring image data of the optical element's surface;
a display for visualizing the image data;
a focus evaluation facility adapted for deriving a focus evaluation value indicating the instantaneous image definition of the acquired image, said focus evaluation value being derived from at least one of: the acquired image data itself and additional signals related to the position of the imaging unit relative to the surface of the optical element, with the focus evaluation value being usable as a focussing aid for manually adjusting the focus; and
a feedback unit adapted for converting the focus evaluation value into a corresponding feedback signal that is communicated to a user.

2. The optical imaging device of claim 1, wherein the optical element is one of: a fiber end, a fiber connection, an optical component in a fiber optic network, or an optical setup.

3. The optical imaging device of claim 1, wherein the imaging unit is a video microscope.

4. The optical imaging device of claim 1, further comprising
a processing unit adapted for receiving the image data acquired by the imaging unit, and for processing said image data.

5. The optical imaging device of claim 1, further comprising
a measuring unit adapted for performing a measurement of an optical property of the optical element, or of an optical property of a fiber optic network the optical element is coupled with.

6. The optical imaging device of claim 5, wherein said measuring unit is adapted for performing at least one of: an optical time domain reflectometer (OTDR) measurement, a WDM measurement, and dispersion measurements.

7. The optical imaging device of claim 5, wherein the processing unit is further adapted for processing the measuring data acquired by the measuring unit.

8. The optical imaging device of claim 1, wherein the processing unit is further adapted for deriving the focus evaluation value from the acquired image data by performing image processing of the acquired image data.

9. The optical imaging device of claim 1, wherein the focus evaluation value is derived from the image data of a predefined region of interest (ROI).

10. The optical imaging device of claim 1, wherein the focus evaluation value is obtained as or derived from the acquired image data by at least one of:
a gradient operator is applied to the acquired image data, and the absolute values of the obtained gradients are summed up;
a Sum Modulus Difference (SMD) of the acquired image data is determined.

11. The optical imaging device of claim 1, wherein the focus evaluation value is derived by determining one- or two-dimensional discrete Fourier transforms of the acquired image data, and by evaluating the spectrum of the obtained spatial frequencies.

12. The optical imaging device of claim 1, wherein the focus evaluation value is derived by evaluating the high-frequency components of the spectrum of spatial frequencies.

13. The optical imaging device of claim 1, wherein the focus evaluation value is derived by integrating, starting at a predefined threshold frequency, the high-frequency components of the spectrum of spatial frequencies.

14. The optical imaging device of claim 1, further comprising additional hardware, preferably an optical triangulation unit, that is adapted for determining the imaging unit's position relative to the surface of the optical element.

15. The optical imaging device of claim 1, wherein the imaging unit's position relative to the surface of the optical element is determined by directing a light beam, preferably a LED or laser beam, to the optical element's surface, and by analyzing the position of the corresponding light spot in the acquired image data.

16. The optical imaging device of claim 1, wherein the imaging unit's position relative to the surface of the optical element is determined by directing a light beam, preferably a laser beam, to the surface of the optical element, with said light beam being reflected by said surface, and by detecting and analyzing the position of the reflected light beam, preferably by means of a multisegment diode.

17. (canceled)

18. The optical imaging device of claim 1, further comprising an acoustic or tactile feedback unit adapted for converting the focus evaluation value into a corresponding acoustic or tactile feedback signal that allows for manually adjusting the focus.

19. The optical imaging device of claim 1, wherein digits or symbols representing the focus evaluation value are presented on the display.

20. (canceled)

21. The optical imaging device of claim 1, further comprising at least one controlled actuator adapted for at least one of:
varying the focus of the imaging unit; and
repositioning the imaging unit relative to the surface of the optical element.

22. The optical imaging device of claim 1, further comprising:
a signal light detection unit adapted for detecting the presence of a signal light component received via the optical element.

23. The optical imaging device of claim 22, wherein the signal light component is a visible or an invisible signal light component, in particular an infrared light component.

24. The optical imaging device of claim 1, further comprising:
a visual inspection tool adapted for coupling visible light into the optical element.

25. The optical imaging device of claim 24, wherein the visual inspection tool comprises a light source, in particular a laser source, that is adapted for emitting a beam of visible light.

26. The optical imaging device of claim 1, further comprising:
a cleaning facility adapted for cleaning the surface of the optical element.

27. The optical imaging device of claim 26, wherein the cleaning facility comprises at least one of: a compressor unit adapted for generating an air jet directed to the optical element's surface, an ultrasonic cleaning facility, one or more brushes adapted for mechanically cleaning the optical element's surface.

28. (canceled)

29. A method for visually inspecting an optical element, the method comprising the following steps:
acquiring image data of the optical element's surface by means of an imaging unit;
deriving a focus evaluation value indicating the instantaneous image definition of the acquired image, said focus evaluation value being derived from at least one of: the acquired image data itself and additional signals related to the position of the imaging unit relative to the surface of the optical element; with the focus evaluation value being usable as a focussing aid for manually adjusting the focus, and
converting the focus evaluation value into a corresponding feedback signal to be communicated to a user.

30. A software program or product, stored on a computer readable medium, for executing the method of claim 29 when run on a data processing system such as a computer.

31. (canceled)
